(19) United States
(12) Patent Application Publication
(10) Pub. No.: US 2026/0113590 A1
(43) Pub. Date: Apr. 23, 2026

(54) Wearable Audio Device for Use in Open Spaces

(71) Applicant: Dopple IP B.V., Assen (NL)

(72) Inventor: Jacobus Cornelis Haartsen, Rolde (NL)

(21) Appl. No.: 19/354,454

(22) Filed: Oct. 9, 2025

Related U.S. Application Data
(60) Provisional application No. 63/708,394, filed on Oct. 17, 2024.

(51) Int. Cl. H04S 7/00; H04R 1/10; H04R 5/033; H04S 1/00

(52) U.S. Cl. CPC H04S 7/304; H04R 1/1091; H04R 5/033; H04S 1/005; H04R 2420/01; H04R 2420/07

(57) ABSTRACT

Each earpiece of a true wireless stereo headset includes a radio receiver outputting a first audio signal of audio content. The audio content is also received by a user's ears via sound waves propagating through the air over a distance, in which at least some spectral components of the audio content are attenuated. The first audio signal is rendered via a loudspeaker, restoring the attenuated components. Due to different flight times, the first audio signal may be time-synchronized to the audio content received from sound waves. The audio content may be received by a microphone exposed to the ambient environment, generating a second audio signal, to which the first audio signal is time-synchronized. The time-synced first audio signal and the second audio signal are combined prior to rendering the sound to the user. This additionally protects the user from hearing loss by attenuating sound waves reaching the user's ear.

### RELATED APPLICATIONS

This application claims the benefit of U.S. Provisional Application No. 63/708,394, filed Oct. 17, 2024, the entire disclosure of which being hereby incorporated by reference herein.

### FIELD OF INVENTION

The present invention relates generally to electronics devices worn in the ear, such as earpieces to listen to music and speeches. In particular, the invention relates to such earpieces used at festival, concerts, and large events.

### BACKGROUND

The use of audio devices, such as headsets and headphones, wirelessly connected to host devices like smartphones, laptops, and tablets, is becoming increasingly popular. Whereas consumers used to be tethered to their electronic devices with wired headsets, wireless headsets are gaining more traction due to the improved user experience, providing the user more freedom of movement and ease of use. Wireless audio devices allow the user to enjoy untethered music entertainment.

Headsets and headphones come in many forms and with many features. Over-the-ear stereo headsets allow immersive listening to high quality sound. In-ear stereo headsets (earpieces placed in the ear canal or in the concha) are more flexible and provide less presence to the user. Most of these in-ear stereo headsets and headphones consist of a left and a right earpiece connected with a cable or neckband. More recent designs offer separate left and right earpieces with no connection between them. Examples of these so-called True Wireless headsets are the Apple AirPods^{®}and the Samsung IconX^{®}.

In many environments, people are exposed to loud sounds. For example, people may visit music festivals where the sound levels are typically above the level where hearing damage may occur. Such environments typically involve large open spaces (e.g., sports arenas, football stadiums, concert halls) with a stage or podium with live performers in front of which the audience is gathered. Heavy amplifiers and loudspeakers are on stage to produce sounds that even the people in the back of the audience, standing at the far end of the field, can hear. Frequently, for considerable periods of time, sound levels rise above the levels generally considered safe for hearing. Therefore, more and more people are wearing earplugs to reduce the sound level arriving at their ear drums, thus avoiding hearing loss which typically results from exposure to loud sound levels for long durations of time.

As sound travels, the sound level decreases and the power density reduces. The attenuation is frequency selective: high-frequency waves attenuate more over the travelled distance than low-frequency waves. This is why the low bass sound of a rock band can be heard hundreds of meters away. Listeners in large open spaces do not experience the same audio quality as the performer/musician on stage. For most people in the audience, the low frequencies in the audio are dominant.

Many people suffer from hearing loss. Partly because they have been exposed to loud sounds in the past or because of aging which is known to affect the human hearing capabilities. Active earpieces that include electronics to amplify and equalize audio signals before they are provided to the loudspeaker in the earpiece may significantly help hearing impaired people in their daily life.

The Background section of this document is provided to place embodiments of the present invention in technological and operational context to assist those of skill in the art in understanding their scope and utility. Unless explicitly identified as such, no statement herein is admitted being prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described and claimed herein, in a true wireless stereo headset, each earpiece receives, via a radio receiver, a first audio signal of audio content. The audio content is also received by a user's ears via sound waves propagating over a distance, in which at least some spectral components of the audio content (particularly high frequency components) are attenuated by propagation through the air. The first audio signal is rendered to the user via a loudspeaker in the earpiece, restoring the attenuated (high frequency) components of the audio content and enhancing the user's audio experience. The wireless stereo headset additionally attenuates sound waves reaching the user's ear, thus protecting the user from potential hearing loss. In some aspects, because the first audio signal propagates at the speed of light and the sound waves propagate at the speed of sound, the first audio signal is time-synchronized to the audio content received from sound waves. A microphone exposed to the ambient environment receives the audio content and generates a second audio signal. The first audio signal is time-synchronized to the second audio signal prior to being rendered to the user. The time synchronization may comprise a coarse synchronization, e.g., in the frequency domain, followed by a fine synchronization, e.g., in the time domain. A number of techniques for fine synchronization are disclosed. The headset may additionally function as a hearing aid, as well as a hearing protection device.

One aspect relates to a method of enhancing audio, performed by a wireless stereo headset worn by a user positioned at a distance from an audio source. Audio content is received from sound waves propagating through the air from an audio source at a distance. A first audio signal is received by a radio receiver. The first audio signal traveled wirelessly from a radio transmitter to the wireless stereo headset. The first audio signal is rendered via a loudspeaker in the earpiece directed towards to the user's eardrum. The first audio signal includes spectral components of the audio content that were attenuated by propagation of the sound waves through the air over the distance.

Another aspect relates to a wireless stereo headset. The headset includes a radio receiver configured to receive a first audio signal wirelessly transmitted from a transmitter. The headset also includes a loudspeaker configured to render the first audio signal and direct the first audio signal towards a user's eardrum. The headset further includes a battery and processing circuitry. The headset is configured to enhance audio content received by the user by the propagation of sound waves through the air over a distance, whereby at least some spectral components of the received audio content are attenuated, by providing the attenuated spectral components of the audio content in the first audio signal.

### BRIEF DESCRIPTION OF THE DRAWINGS

The present invention will now be described more fully hereinafter with reference to the accompanying drawings, showing several embodiments of the invention. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 shows a high-level schematic diagram of an exemplary use scenario with a performing artist and an audience.

FIG. 2A shows the attenuation in dB per m as a function of the frequency.

FIG. 2B shows the attenuation of high frequencies of a typical song.

FIG. 3A shows a high-level schematic diagram of aspects of the invention with a user receiving audio both via the air and via a wireless connection.

FIG. 3B shows the sound delay on the air channel and the delay on the wireless channel as a function of the distance between the stage and the listener.

FIG. 4 is a schematic block diagram of an exemplary wireless earpiece according to aspects of the invention.

FIG. 5 is a high level block diagram of a circuit to implement a first method to time-synchronize the audio arriving via the air channel and the audio arriving via the wireless channel according to aspects of the invention.

FIG. 6 is a flow diagram of a method of enhancing audio by a wireless stereo headset.

FIG. 7 is block diagram of a circuit using spectral correlation to obtain a coarse timing synchronization according to aspects of the invention.

FIG. 8 is a block diagram of a circuit according to a first embodiment to obtain a fine timing synchronization.

FIGS. 9A-9C show correlation signals as a function of the delay for early, late and optimal reception.

FIG. 10 shows an example of the correlation signals as created by the circuitry depicted in FIG. 8.

FIG. 11 is a flow diagram of a method to achieve coarse and fine synchronization using the circuits as shown in FIGS. 7 and 8, as described with reference to FIGS. 9A-9C and 10.

FIG. 12 is a block diagram of a first circuit according to a second embodiment to obtain a fine timing synchronization.

FIG. 13 is a block diagram of a second circuit according to the second embodiment to obtain a fine timing synchronization.

FIG. 14 is a block diagram of a third circuit according to the second embodiment to obtain a fine timing synchronization.

FIG. 15 s a block diagram of a fourth circuit according to the second embodiment to obtain a fine timing synchronization.

FIG. 16 is a flow diagram of a method to obtain a fractional delay to be used for fine synchronization.

FIGS. 17A-17D show the derivation of a fractional delay using up-sampling and down-sampling.

FIG. 18 is a high level block diagram of a circuit to implement a second method to time synchronize the audio arriving via the air channel and audio via the wireless channel according to aspects of the invention.

FIG. 19 is a high level block diagram of a circuit to implement a third method to time synchronize the audio arriving via the air channel and the audio via the wireless channel according to aspects of the invention.

FIG. 20 is a high level block diagram of a circuit to implement a method providing transparency to time synchronize the audio arriving via the wireless channel to the audio arriving via the microphone according to aspects of the invention.

### DETAILED DESCRIPTION

For simplicity and illustrative purposes, the present invention is described by referring mainly to exemplary embodiments thereof. In the following description, numerous specific details are set forth in order to provide a thorough understanding of the present invention. However, it will be readily apparent to one of ordinary skill in the art that the present invention may be practiced without limitation to these specific details. In this description, well-known methods and structures have not been described in detail so as not to unnecessarily obscure the present invention.

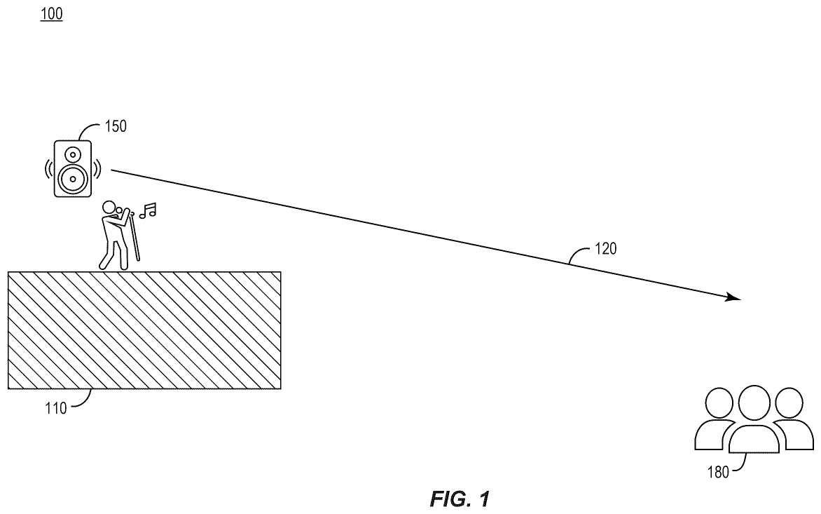

Since the nineteen sixties, people have been attending music festivals. These festivals have become very popular and have grown to big events, sometimes spanning multiple days. These events can easily attract thousands of people requiring venues as large as sports arenas or football stadiums. A typical scenario encountered during such events is shown in FIG. 1. The performing artist at stage or podium 110 can be tens of meters (for football stadiums even close to a hundred meters) away from the listeners 180 at the back. Large electronic amplifiers and loud speakers 150 are used to amplify and produce the sound created by the performers. Via sound waves 120 travelling through the air, the sound reaches the listeners 180. Because exposure to loud sounds for longer duration of time will cause hearing damage, more and more people are wearing hearing protection. Passive plugs, preferably with flat filters, dampen the loud sounds, especially those close to the stage that are the most damaging.

Listeners at the back do not experience the same audio quality as listeners close to the stage. This is because the audio signals are distorted while travelling through the air. This becomes especially noticeable when the sound travels over tens of meters as is occurring at festivals in open spaces. When sound travels through the air, some of its energy is absorbed by the air itself as heat. High-frequency waves are absorbed more than low-frequency waves.

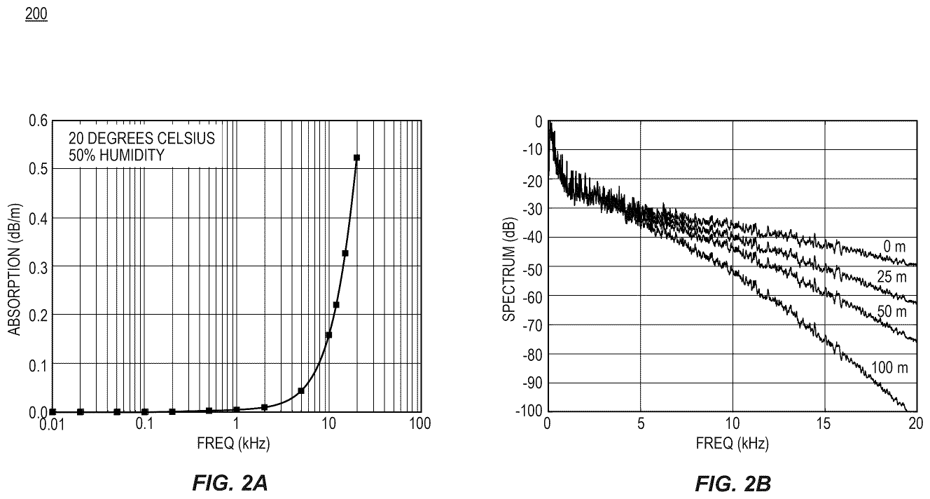

FIG. 2A depicts the absorption in dB per m as a function of the frequency (at 50% humidity and at a temperature of 20 degrees Celsius). The absorption starts to rise quite sharply at frequencies above 2 kHz. This is why the low bass sound of a rock band (but not the midrange or treble) can be heard hundreds of meters away.

FIG. 2B shows what this frequency-selective attenuation does to the audio signal. In this figure, the spectral density in dB of a sound track of a singer with his band is shown. The upper curve (0 m) represents the original spectrum as produced by the band. The effect of the distance on high-frequency audio spectrum is shown at distances of 25 m, 50 m, and 100 m. The air behaves like a low-pass filter. At a distance of 50 m, audio signals at 8 kHz have already been attenuated by 10 dB. Depending on the listener's age, the loss of high frequencies is more noticeable. Assuming a healthy population with no hearing impairment, people of all ages will hear the 8 kHz, people under 50 should be able to hear the 12 kHz, people under 40 the 15 kHz, people under 30s the 16 kHz, and the 17 kHz is receivable for those under 24.

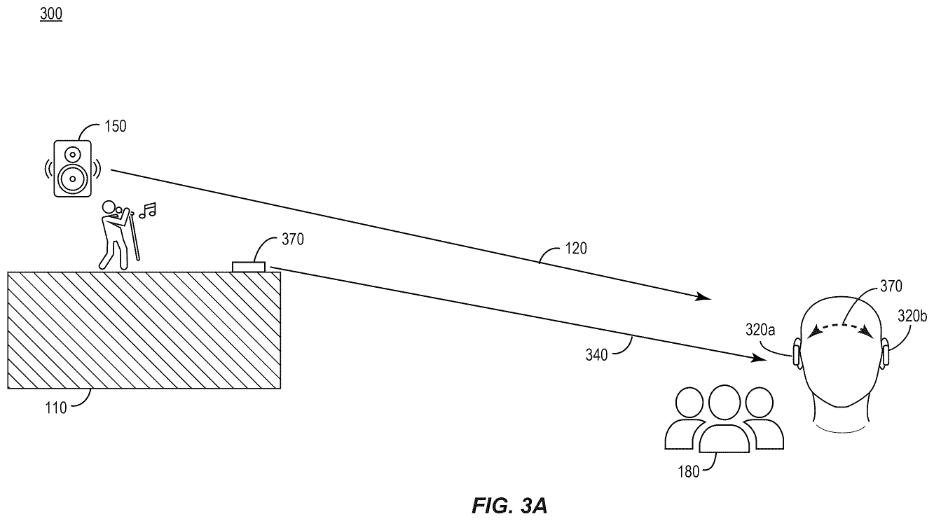

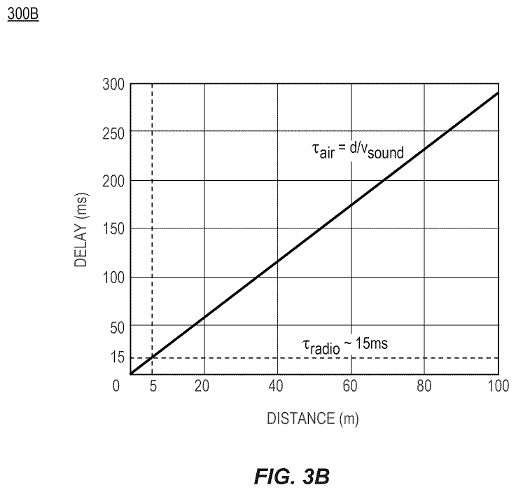

In FIG. 3A, aspects of the present disclosure are shown to compensate for the loss of high frequency audio. In addition to the audio reaching the listener via sound waves 120 in the air, the audio reaches the listeners via a wireless link 340 using a headset 320. The audio signals sent via the wireless link 340 will include the high frequency content which is lost in the sound waves 120 travelling through the air, thus restoring the audio quality also for users at the back. A transmitter 370 broadcasts the audio signals over wireless link 340 which are received by a receiver in the right earpiece 320a and/or left earpiece 320b of the headset 320 worn by the listener. Headset 320 preferably consists of two separate earpieces, forming a so-called True-Wireless headset. Communication between the earpieces 320a, 320b (ear-to-ear or e2e communications) is provided via connection 370 which is preferably wireless as well. In addition to receiving audio via wireless link 340, earpieces 320a and 320b may also serve as hearing protection to prevent loud sounds from reaching the listener's eardrum.

The transmitter 370 can be located on stage as shown in FIG. 3A, but it can also be located at other places on the premises (not shown), for example at the back end of the venue. Possibly, multiple transmitters may be dispersed over the venue. Typically, the earpieces will automatically connect with the nearest transmitter. Several wireless technologies for link 340 can be considered, for example WiFi or Bluetooth^{®}. Preferably, the broadcast mode of Bluetooth Low Energy, branded as Auracast^{®}, is used. The transmitters derive their audio signals from the mixing table at the stage, similar to the audio signals sent to the loudspeakers 150 or the audio signals sent to the in-ear monitors of the performing artists. Alternatively, the transmitter may send several audio streams in parallel, and the user can select (e.g., via an app on his phone) which stream he likes to listen to. For example, he can select a particular channel to hear what the drummer hears in her/his in-ear monitors, or select a particular channel to hear what the singer hears in her/his in-ear monitors. The wireless signal 340 will compensate for the loss of high-frequency components experienced by the travelling air waves 120.

By properly processing the received audio signals in headset 320, the radio signal 340 may also be used to compensate for personal hearing loss due to age or exposure to loud noises in the past. Proper hearing aid functions can be implemented in the earpieces 320a, 320b to further improve the audio quality for the listener, i.e., by boosting certain frequency components before the audio is presented to the loudspeaker in the headset.

A challenge in the scenario 300 is the difference in propagation delay of the signals arriving at user via the sound waves 120 and arriving at user via the wireless connection 340 using radio waves. Depending on humidity and temperature, sound waves travel at a velocity between 343.4 and 344.8 m/s. In contrast, signals sent via radio waves travel at the speed of light, i.e. 300,000,000 m/s. This means that the radio waves 340 arrive at the headset much earlier than the sound waves 120 via the air. In FIG. 3B, the delay of sound waves ^{τ}air is shown as a function of the distance, assuming a sound velocity of 344 m/s. For the festival scenario 300, the delay ^{τ}radio in the wireless link 340 will not be determined by the distance, but by the delay introduced in the protocol of the wireless link 340. The audio must be digitized, encoded using audio frames, sent in packets over the air, decoded, etc. Typically, the end-to-end delay ^{τ}radio on the radio link 340 is 15-20 ms, depending on the protocol. In FIG. 3B, it can be discerned that even at a distance of 5 m away from the stage, the delay ^{τ}air of the sound waves 120 exceeds the delay of the radio signals 340. Further away from the stage, the delay ^{τ}air of the air waves 120 may be hundreds of milliseconds, whereas the radio delay ^{τ}radio only amounts to a few tens of milliseconds. Hearing protecting earpieces 320 will not be able to completely prevent the sound waves 120 travelling through the air from reaching the listener's eardrum. Low frequencies will pass the earpieces even if the earpieces are used for hearing protection (low frequencies are not that damaging anyway). Low frequencies are “felt” by the entire body, and will propagate through the body and reach the eardrum. Furthermore, earpieces 320 may use a transparency mode to partly pass the air waves 120 (for example to be able to communicate with nearby persons). This all means that audio will reach the eardrum both generated by air waves 120 and by audio waves generated by the loudspeakers in the headset 320 obtained from the wireless link 340. When there is a substantial delay between two audio signals (say 5 ms or more), the listener will experience an echo. The echo is more severe when the delay difference increases. It is therefore required that the two audio signals are somehow time-synchronized so that they reach the eardrum substantially at the same time.

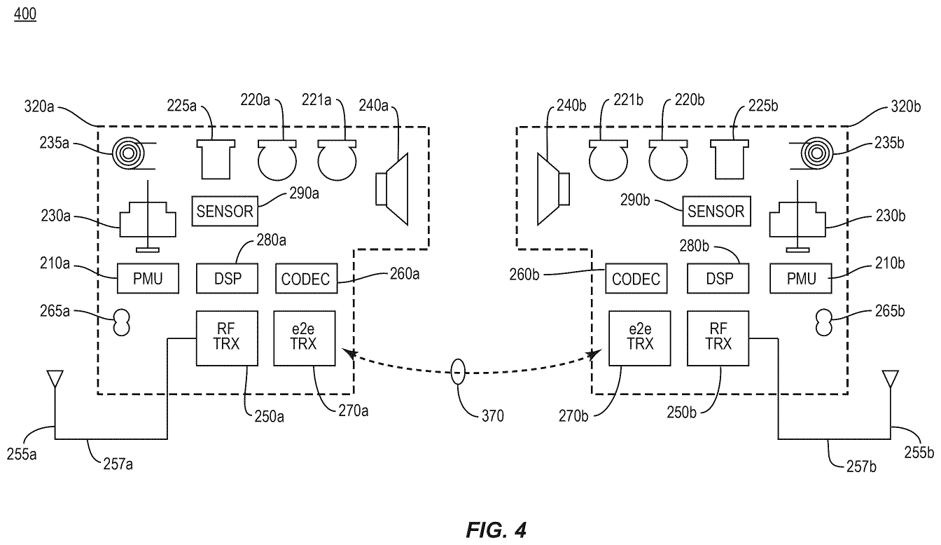

FIG. 4 show a high-level functional schematic diagram 400 of an exemplary wireless stereo headset consistent with aspects of the present disclosure. Not all components may be needed for the headset 320 used in the scenario 400 as shown in FIG. 4, and some components may be omittted, e.g., for a low-cost version. On the other hand, schematic 400 may not be exhaustive and more components may be added to increase the functionality of headset 320. Earpieces 320a and 320b consist substantially of the same components, although the placement inside the earpiece (e.g. on a printed circuit board or PCB) may be different, for example mirrored.

Wireless communications via link 340 between the transmitter 370 and the headset 320 is provided by an antenna 255a and a radio transceiver 250a in the right earpiece 320a, and/or is provided by an antenna 255b and a radio transceiver 250b in the left earpiece 320b. Antennas 255a and 255b are dimensioned to receive and transmit radio signals at carrier frequencies in the GHz range, for example carrier frequencies that are found in the 2.4 GHz ISM band ranging from 2400 MHz to 2483.5 MHz and used by WiFi and Bluetooth. Antennas 255a and 255b are connected via connectors 257a and 257b to radio transceivers 250a and 250b. Radio transceivers 250a and 250b are low-power radios covering short distances, for example radios based on the Bluetooth^{®}wireless standard (operating in the 2.4 GHz ISM band). The use of radio transceivers 250a and 250b, which by definition provide two-way communication capability, allows for efficient use of air time (and consequently low power consumption) because it enables the use of a digital modulation scheme with an automatic repeat request (ARQ) protocol.

One-way communication may be provided via a broadcast protocol defined in the Bluetooth specifications, which relies on unconditional retransmissions for increased reliability. Transceivers 250a and 250b may include a microprocessor (not shown) controlling the radio signals, applying audio processing (for example voice processing such as echo suppression or music decoding) on the signals received by radio transceivers 250a and 250b, or may control other signal paths within the earpieces 320a and 320b, respectively. Alternatively, audio processing may be carried out in a separate digital signal processor (DSP) 280 in the earpiece 320, or may be in a digital processor integrated into another component present in the earpiece, i.e., integrated into codec 260. Advanced audio algorithms may be carried out in DSP 280 such as beam forming, echo cancellation, and noise suppression (including active noise cancellation, ANC). Additionally or alternatively, advanced hearing aid algorithms may be carried out in the DSP 280 to improve the hearing capabilities of the user. The algorithms may make use of Artificially Intelligence and/or Machine Learning (ML) algorithms. A Neural Network Processor (NNP) may be present (not shown). The NNP may be embedded in DSP 280 or radio transceiver 250. Using parameters found via ML, the NNP allows low-power, always-on processing capabilities, for example for Voice Activation Detection (VAD), HotWord detection (HWD), KeyWord detection (KWD), and Context detection. The NNP may use a Convolutional Neural Network (CNN), a Deep Neural Network (DPP), or a Recurrent Neural Network (RNN), or combinations thereof, as non-limiting examples.

Codecs 260a and 260b include Digital-to-Analog (D/A) converters, the outputs of which connect to a right loudspeaker 240a and left loudspeaker 240b, respectively. For embodiments that include a voice and/or transparency (including hearing aid functionality) mode, the codecs 260a and/or 260b may further include Analog-to-Digital (A/D) converters that receive input signals from analog air microphones 220a and 220b, respectively. To obtain beamforming for enhanced voice pickup, more than one microphone 220 (not shown in FIG. 4) may be embedded in one earpiece, then also requiring additional Analog-to-Digital (A/D) converters in the codec 260. To support ANC, an in-ear microphone 221 may be placed in front of the loudspeaker 240. Instead of analog microphones, digital microphones that do not need A/D conversion may be applied that feed their outputs directly to the microprocessor or the DSP 280.

In addition to air microphones picking up the sound through air waves, vibration sensors 225a and/or 225b may be added that pick up acoustic vibrations. Vibration sensors may pick up the mechanical vibrations in the human skull caused by the user's vocal cords, or external sounds that hit the human body via air waves 120. Vibrations may be picked up via the skin (Skin Surface Microphones), from the bones (Bone Conduction microphone), or from other tissues in the user's head. The vibration sensor 225 may, for example, be implemented using Micro-Electro-Mechanical Systems (MEMS) technology.

Sensor(s) 290 may be provided to detect certain user characteristics or events. For example, an acceleration sensor may be added to detect movement, or an infrared sensor may be added for in-ear detection or for measuring physiological characteristics such as the user's heart rate or oxygen saturation level in his/her blood. One or more Light Emitting Diodes (LEDs) may be added to allow Photoplethysmography (PPG) for detection of the heart rate and/or or oxygen saturation level. Magnetic sensors may be added for orientation detection (i.e. measuring Earth magnetic field to determine whether the user lies down, on his/her back, or on his/her left or right side) or for detecting bruxism, and possibly heartrate and breathing. LEDs and sensors may also be used for User Interface (UI) purposes to control miscellaneous functionality in the headset 320. LEDs may indicate status (wireless connection active, battery low, and so on). UI may be accomplished by buttons (not shown in FIG. 4), by sensors for detecting gestures (gesture control), and so on. Alternatively, UI may be provided via a smartphone (not shown). Advanced algorithms may be carried out in DSP 280 to process the sensor signals. The sensor signals may be sent wirelessly to a smartphone which may forward this information to a server in the cloud for storage or to a care professional. The algorithms may use Artificially Intelligence and/or Machine Learning algorithms, and may reside partly or completely in the DSP 280, in a smartphone, and/or reside in the cloud.

Each earpiece is powered by battery 230 which typically provides a 3.7V voltage and may be of the coin cell type. The battery 230 may be a primary battery, but is preferably a rechargeable battery. Power Management Units (PMU) 210a and 210b provide stable voltage and current supplies to all electronics circuitry, and also provide charging support functions to charge a rechargeable battery when the earpiece is placed in a charging station or cradle (not shown). The charging may be wired through galvanic contacts 265 and/or may be wireless using magnetic coupling. In the latter case, a receive coil 235 is needed to pick up the magnetic fields provided by a charging station.

To provide communications between the left and right earpiece, an ear-to-ear (e2e) link 370 is provided. The e2e transceivers 270a and 270b implement the communication over e2e link 370. Link 370 may use magnetic coupling, for example using the Near-Field Magnetic Induction (NFMI) technology as provided by NXP NFMI radio chip Nx2280, or may use an RF link. Preferably, link 370 makes use of an RF protocol substantially the same as used in the broadcast link 340, e.g. Bluetooth. In that case, the e2e transceivers 270a and 270b may reuse the circuitry of RF transceivers 250a and 250b.

In the scenario 300, the need for timing synchronization was explained in order that the audio via the sound waves 120 and the audio via the wireless link 340 arrive at the user's eardrums at substantially the same time. The delay ^{τ}radio on the wireless link 340 is constant and typically on the order of a few tens of milliseconds. The delay ^{τ}air of the sound waves 120 depends on the distance between the listener and the stage and can easily amount to a few hundreds of milliseconds. Timing synchronization can be obtained by delaying the audio signals derived from the wireless link 340 and time synchronizing them with the audio received via sound waves 120. Since the sound waves delay ^{τ}air depends on the distance, the timing synchronization must be adaptive, and must be adjusted when the user moves closer to, or further away from, the stage.

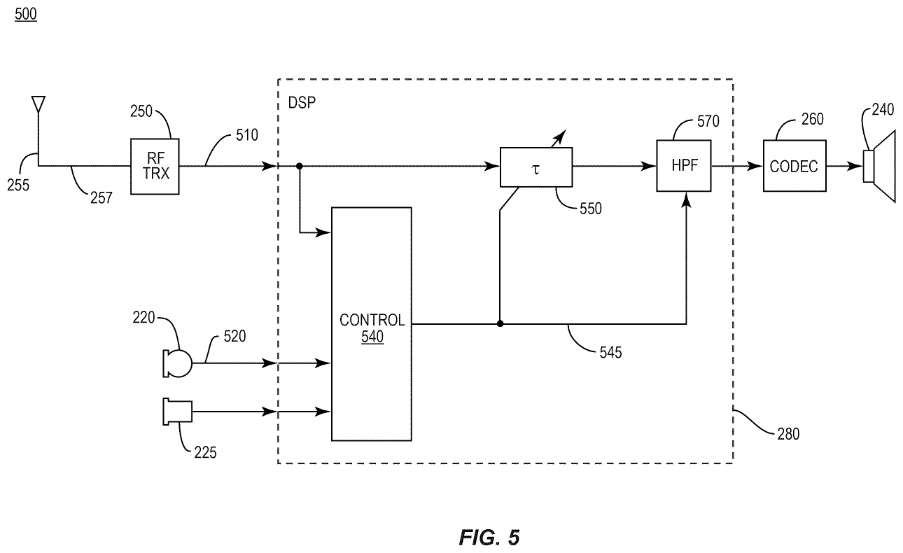

FIG. 5 shows a high level block diagram of a circuit to implement a first method to time-synchronize the audio signals arriving via the air waves 120 and the audio signals arriving via the wireless link 340 according to aspects of the present disclosure. Control block 540 receives audio stream 510 from the radio 250 and the audio stream 520 from the sound waves picked up in air microphone 220. Possibly, the audio stream of the vibration sensor 225 can also be used instead of, or in addition to, the audio stream from the air microphone 220. Control block 540 determines the delay between the two audio streams 510 and 520. This delay is subsequently provided via control signal 545 to delay element 550, which delays the audio stream 510 derived from the wireless link 340. Before being provided to the audio codec 260 and loudspeaker 240, a high-pass filtering 570 may be applied to reduce the low-frequency content, since low-frequency components may already reach the eardrum via the sound waves 120. The filter characteristics may be adaptive, depending on the distance between the listener and the stage (which determines the amount of high-frequency attenuation by the air). This distance is represented by the delay as provided by the control block 540 via control signal 545. Control block 540, delay element 550, and/or filter 570 may be implemented as separate components or (partly or entirely) as an algorithm in DSP 280.

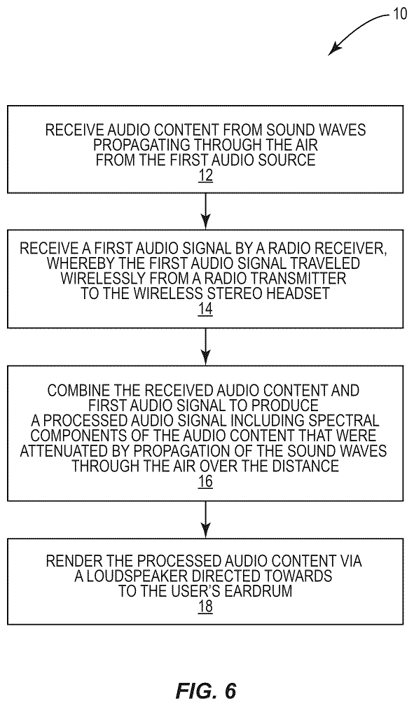

FIG. 6 shows the steps in a method 10 of enhancing audio. The method 10 is performed by a wireless stereo headset 320 worn by a user, who is positioned at a distance from a first audio source 150 producing audio content. Audio content is received from sound waves propagating through the air from the first audio source 150 (block 12). A first audio signal 510 is received by a radio receiver 250. The first audio signal 510 traveled wirelessly from a radio transmitter 370 to the wireless stereo headset 320. The received audio content and first audio signal 510 are combined to produce a processed audio signal that includes spectral components (e.g., high frequencies) of the audio content that were attenuated by propagation of the sound waves through the air over the distance. The processed audio content is rendered via a loudspeaker 240 directed towards to the user's eardrum.

The method of timing synchronization in control block 540 (FIG. 5) may involve several steps. According to aspects of the present disclosure, first a coarse synchronization (coarse tuning) is applied to synchronize the audio stream 510 within a few milliseconds to audio stream 520. Once a coarse synchronization is achieved, a fine synchronization (fine tuning) is applied in order to synchronize the audio streams within a few microseconds.

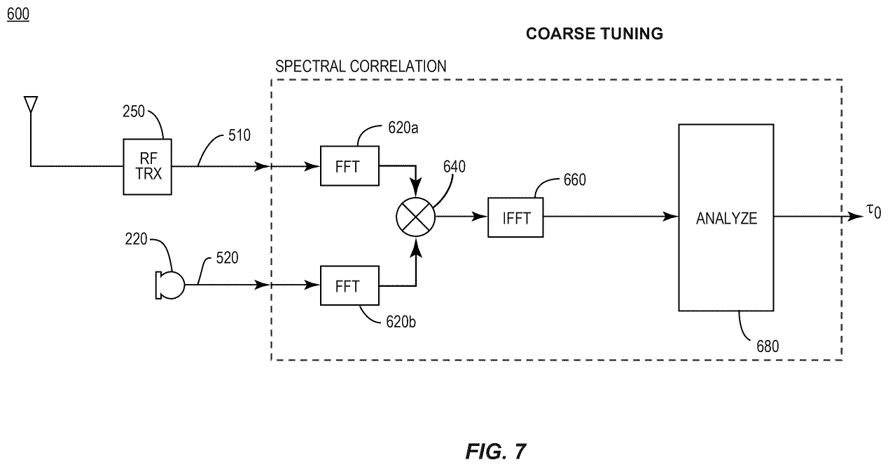

FIG. 7 shows an example of a circuit for coarse tuning. Preferably, this synchronization applies processing in the frequency (spectral) domain. To synchronize two signals in the time domain, time correlation is applied. In the frequency domain, this translates into a multiplication of the Fourier transformed signals. First, a number of M audio samples, for example, covering a time duration of 2 seconds, are collected of both audio stream 510 and of audio stream 520. When, for example, an audio sample rate of 48 ks/s is used, 2 seconds of audio will encompass 96,000 audio samples. Each frame of M samples is subsequently transformed into the frequency domain using a Fast Fourier Transform (FFT) in block 620. The outputs of the FFT blocks 620 are multiplied in 640. The multiplier output signal is then converted back into the time domain using an Inverse Fast Fourier Transform (IFFT) in block 660. In analyzing block 680, from the output signal of block 660 the maximum correlation and the corresponding delay ^{τ}0 is determined. After coarse tuning, fine tuning can be applied, which is preferably carried out entirely in the time domain.

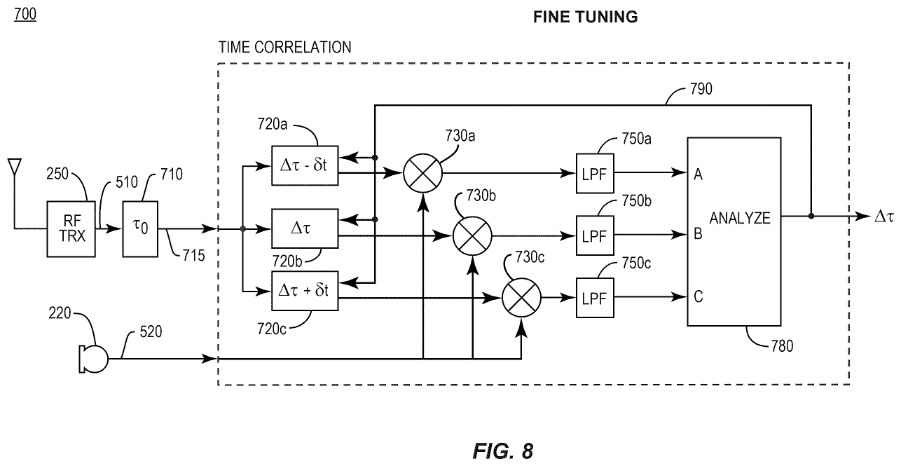

FIG. 8 shows a first embodiment 700 for fine tuning. First, the audio stream 510 derived from the wireless link 340 is delayed in delay element 710 by the delay ^{τ}0 found in the coarse tuning step. Thereafter, the delayed stream 715 is split over three audio streams that are fed to three delay elements 720a, 720b, and 720c, which provide incremental delays of Δτ−δt, Δτ, and Δτ+δt, respectively. The parameter δt is a fixed time delay of one or a few sample periods. When the audio processing runs at a sample rate of 48 ks/s, a sample period corresponds to 20.83 microseconds. The three delayed audio streams are subsequently multiplied in multipliers 730 with the audio stream 520 derived from the sound waves picked up by microphone 220. Low-pass filters (LPF) 750 provide an integration function which finalizes the time correlation process. The outputs of the low-pass filters 750 are provided to inputs A, B and C of analyze block 780 which compares the correlation values of the three streams. Based on the comparison, the fine delay Δτ is determined and via feedback path 790 provided back to the three delay elements 720.

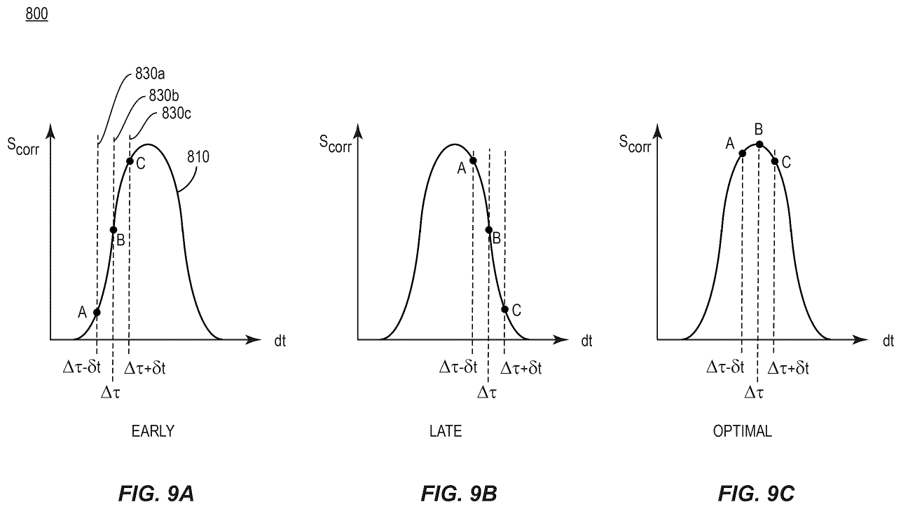

FIG. 9 depicts graphs that better explain the time correlation process. Shown is the correlation value S_{corr} as function of the time difference Δτ between the two input signals 715 and 520. At the optimal delay Δτ the maximum S_{corr} is obtained. In FIGS. 9A-C, the correlation values 830 represented by the LPF outputs 750, which are fed to inputs A, B, and C of analyzing block 780, are shown for the cases that Δτ is too small (early FIG. 9A), too large (late FIG. 9B), or optimal (optimal FIG. 9C). Comparing the values A, B, and C, analyzing block 780 determines whether to increase or decrease in order to arrive at the optimal situation in FIG. 9C, where B>A and B>C. From the graphs in FIG. 9, it can be derived that when A<B<C, the time delay Δτ should be increased (FIG. 9A), whereas when A>B>C, the time delay Δτ should be decreased (FIG. 9B).

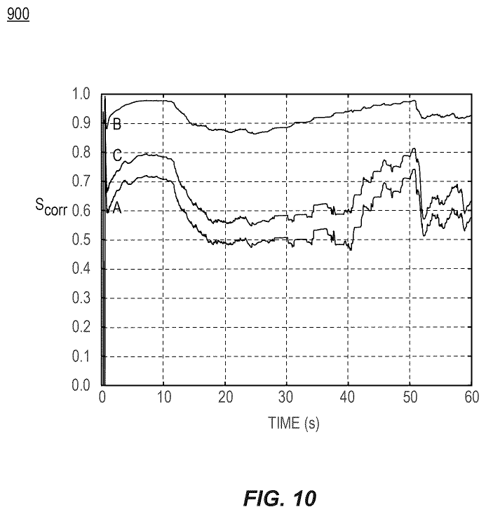

FIG. 10 shows an example where the audio of a sound track of a singer with his band is travelling over 75 m distance (corresponding to a sound wave delay of about 218 ms). The correlation signals input to A, B, and C recorded during a 60 s period are shown. For early and late detection, 12 audio samples at 48 ks/s sampling were used (dt=0.25 ms). For the LPF 750, an exponential forget Infinite Impulse Response (IIR) filter was used with a time constant of 5 seconds. In this example, the value of B always remained higher than A and C and no change in the delay Δτ was necessary.

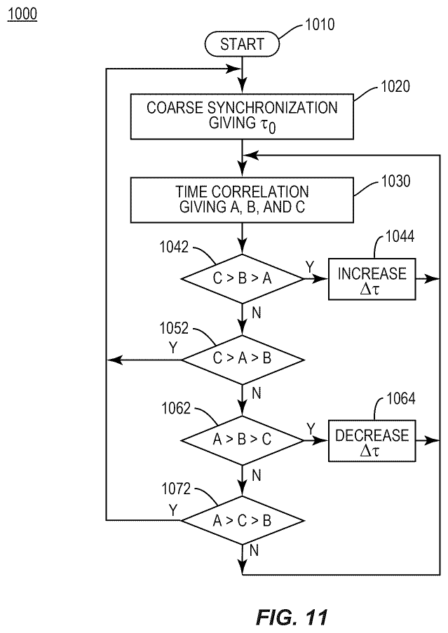

FIG. 11 shows a flow diagram of the algorithm carried out in analyzing block 780. After start block 1010, a coarse timing synchronization is carried out in block 1020, for example using spectral analysis in the frequency domain with the circuit depicted in FIG. 7. This yields the coarse delay. Next, in block 1030 a fine timing correlation is carried out at different delays, giving the correlation results for A (early), B (nominal), and C (late). Next, signals A, B, and C are compared in blocks 1042, 1052, 1062, and 1072. If C>B>A (‘Yes’ in block 1042), the situation corresponds to FIG. 9A, meaning that the radio-derived audio signal is too early and the time delay should be increased (block 1044). If ‘No’ in block 1042, it is tested whether C>A>B (block 1052). If yes, fine tuning cannot be applied because the nominal value B represents the minimum correlation. This may be caused by the fact that error in the initial delay ^{τ} is excessive. In this case (‘Yes’ in block 1052), the algorithm returns to the coarse synchronization block 1020. If ‘No’ in block 1052, it is tested whether A>B>C (block 1062). If ‘Yes’, the situation corresponds to FIG. 9B, meaning that the radio-derived audio signal too late and the time delay Δτ should be decreased (block 1064). If ‘No’ in block 1062, it is tested whether A>C>B (block 1072). If ‘Yes’, fine tuning cannot be applied because the nominal value B represents the minimum correlation. This may be caused by the fact that error in the initial delay ^{τ}0 is excessive. In this case (‘Yes’ in block 1072), the algorithm returns to the coarse synchronization block 1020. If ‘No’ in block 1072, the current time delay Δτ is still the optimal value since B is larger than A and larger than C. In that case, the value Δτ needs no change. Optimal delay is achieved if B>A, B>C, and A˜C. Because of the discrete time samples, the latter condition (A˜C) may not be achievable. A better accuracy of Δτ can be obtained by running the circuitry 700 at a higher audio sampling rate, for example at 192 ks/s. Alternatively, a fractional delay may be realized in delay elements 720, meaning that the delay does not have to be a multiple of a sample period, but can be a fraction of that. This will be explained in the second embodiment for the fine tuning.

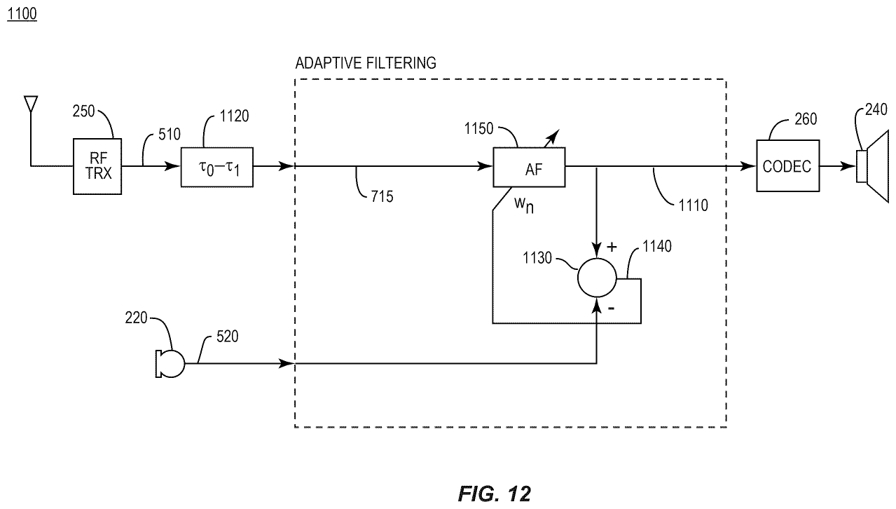

FIG. 12 shows a second embodiment 1100 for fine tuning. This fine tuning method is also applied in the time domain, but uses adaptive filtering (AF). The adaptive filter 1150 is a Finite Impulse Response (FIR) filter, the filter coefficients wₙ of which are dynamically adjusted to minimize the power in the error signal 1140, which is the output of subtractor 1130. The filter coefficients wₙ may be calculated based on the error signal 1140 using a Least Mean Square (LMS) algorithm, as described for example in the article “Adaptive Noise Cancelling: Principles and Applications,” by B. Widrow et al., published in Proceedings of the IEEE, Vol. 63, No. 12, December 1975, the disclosure of which is incorporated herein by reference in its entirety. In one aspect, to allow for variations in amplitude levels, a Normalized Least Mean Square (NLMS) algorithm is applied. Adaptive filters are common practice and for example are being used in echo cancellers applied in numerous audio communication products. Other types of adaptive filters that provide suitable transfer functions to create a dynamic delay function may be used as well. The weights wₙ are continuously updated using the input samples 715 of the AF and the error signal 1140. Audio stream 510 is first delayed in delay element 1120 by the delay ^{τ}0^{-τ}1. The parameter ^{τ}0 is found in the coarse tuning step. Parameter ^{τ}1 has a fixed value, and is applied to substantially center the impulse response of the adaptive FIR filter 1150 (i.e., in a sense it allows AF 1150 to realize both positive and negative delays). The value of ^{τ}1 depends on the length of this adaptive FIR filter 1150. The energy of error signal 1140 is minimized when the output of the adaptive filter 1150 best matches the signal 520 provided by the microphone 220. The additional delay in adaptive filter 1150 will thus result in a near-perfect timing synchronization of signal 1110 and signal 520.

Since the weights wₙ of the adaptive filter are dynamically adjusted so that the filter output 1110 will match the signal 520, not only the timing is matched (phase response), but also the amplitude response is matched. Since signal 520 results from the sound waves which are low-pass filtered while propagating through the air, AF 1150 will also converge to a low-pass filter amplitude response. As a result, high frequencies in signal 1110 are attenuated, undoing the purpose of the wireless link 340, which is to provide the listener with the full audio spectrum, including the high frequencies. Therefore, from the adaptive filter, only the phase (timing) information is preferably extracted, not the amplitude information.

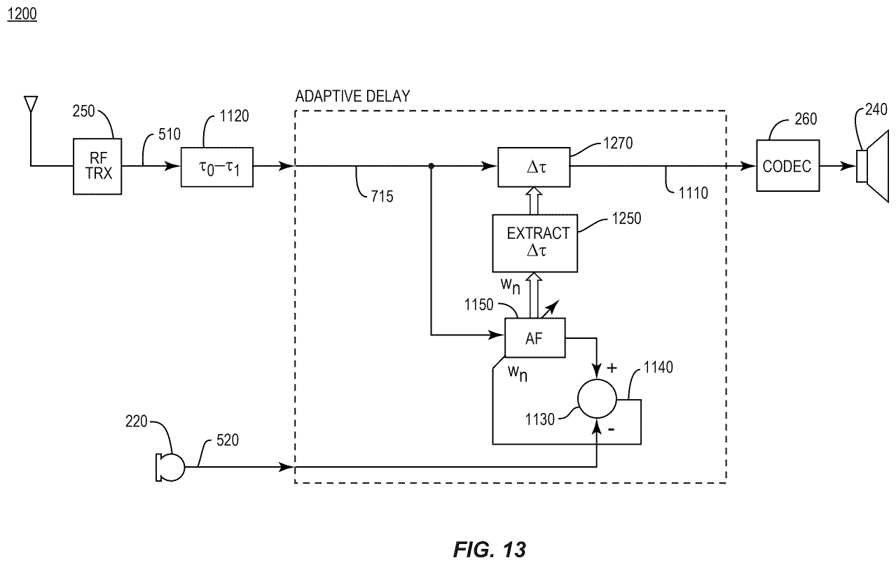

FIG. 13 shows one aspect 1200 to achieve this. The delay signal 1110 provided to the codec 260 and loudspeaker 240 is not derived from the AF 1150 directly. From the AF coefficients wₙ, the (fractional) delay Δτ is extracted in block 1250. This delay Δτ is used in variable delay element 1270. Delay element 1270 can also be considered to be a variable filter with coefficients vₙ, but with a flat amplitude response; i.e., the impulse response only results in a delay.

In FIG. 14, a more compact solution 1300 is presented where the output of the variable delay element 1270 is used to create the error signal 1140. From the weights wₙ derived from the audio samples 715 and the error signal 1140, the optimal delay Δτ is extracted, i.e., the weights vₙ for delay element 1270.

In the diagrams 600, 700, 1100, 1200, and 1300 of the second embodiment for fine tuning, the audio signal carried over wireless link 340 is compared with the audio detected on the external microphone 220 to achieve timing synchronization.

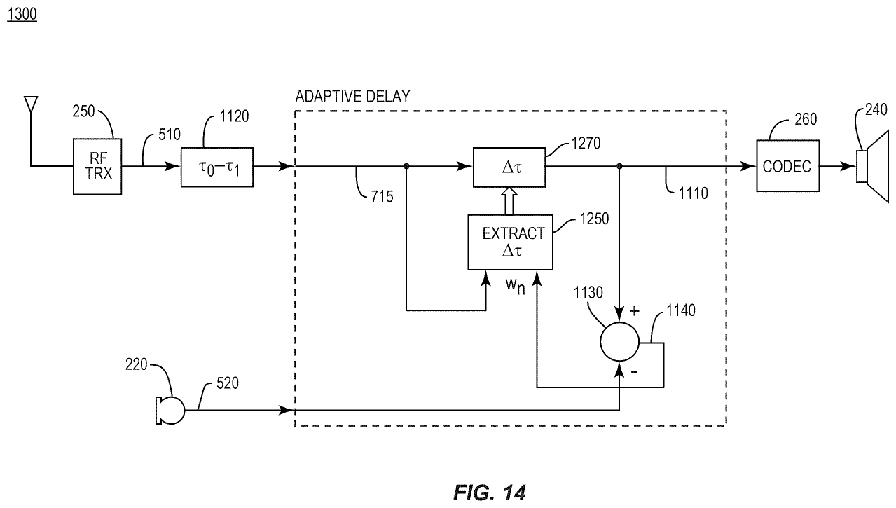

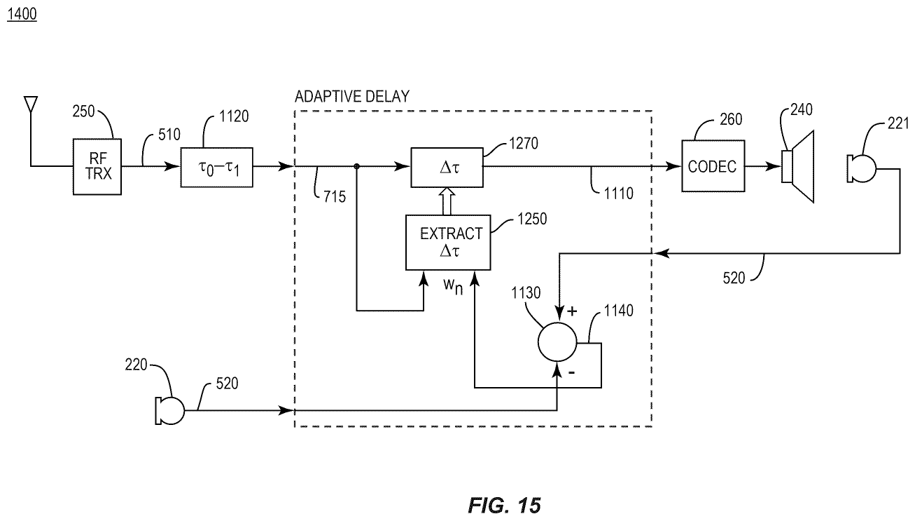

FIG. 15 shows an embodiment 1400 in which the audio signal received by radio 250 is played back on loudspeaker 240, picked up by in-ear microphone 221 and the in-ear microphone signal is now compared with the audio detected on the external microphone 220 to achieve timing synchronization. This will also take into account any additional delay incurred by codec 260 and loudspeaker 240 (although this delay is usually very small). Microphone 221 is located in a position where it picks up the sound generated by loudspeaker 240. Typically, this microphone is used for Active Noise Cancellation (ANC) using feedback, or to detect leakage of the earpieces in hearing protection scenarios. The audio signals from the external microphone 220 are subtracted from the audio signals coming from in-ear microphone 221, to produce an error signal 1140. From this error signal 1140, the delay is dynamically extracted in block 1250, which is required to time synchronize the audio signals arriving via the air and those arriving via the radio. In one aspect, the audio from the in-ear microphone 221 is filtered (not shown) before being provided to adder 1130. When the earpiece has turned on transparency, allowing certain environmental sounds to reach the eardrum, and/or when there is leakage from outside sounds into the ear canal, the in-ear microphone 221 will not only pick up the audio from the radio 250 via the loudspeaker 240, but will also pick up audio from the sound 120 travelled via the air waves. These additional sounds may disturb the timing synchronization procedure that is required to synchronize the audio signals received via the wireless link 340. For example, when there is much leakage from low frequency environmental sounds into the ear canal, a high-pass filter after the in-ear microphone 221 may be applied to suppress the disturbing signals in the feedback loop.

In the diagrams 600, 700, 1100, 1200, and 1300 of the second embodiment for fine tuning, the radio signal is delayed by ^{τ}0^{-τ}1^{+Δτ} where ^{τ}0 is the initial coarse delay, and ^{τ}1 is an offset to allow Δτ, the delay from the fine tuning, to be positive or negative. Preferably, the resolution in the delay ^{τ}0^{-τ}1^{+Δτ} is only a fraction of the sample period. This can, of course, be achieved by running the entire audio processing circuit at a higher sampling rate than the sampling rate used in the radio codecs and the microphones 220 and 221. For example, typically over a Bluetooth link, the audio sampling rate for music ranges up to fₛ=48 ks/s. The resolution in the delay would amount to 20.83 microseconds. One could improve the resolution by up-sampling the audio signals using a sample rate converter to, for example, an audio sampling rate of 192 ks/s. However, running at higher sampling rates will require higher clock rates and more power consumption of the digital circuitry.

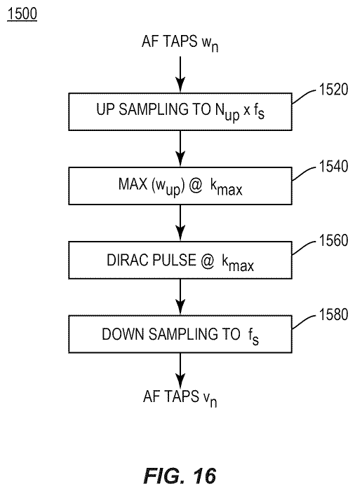

FIG. 16 shows a flow diagram 1500 where the up sampling is only applied in the delay extraction block 1250. Firstly, in a sample rate conversion step 1520, the weights wₙ of the adaptive filter are up-sampled by a factor of Nᵤₚ. For example, if the input sampling rate is 48 ks/s, an up-sampling factor Nᵤₚ of 4 would result in up-sampled weights w_{n,up} sampled at 192 ks/s (resulting in a resolution in the delay of 5.21 microseconds). Then, in block 1540, the maximum in the weights w_{n,up} is determined; in particular, the sample point kₘₐₓwhere the maximum is found in the series w_{n,up} is determined. This kₘₐₓ is subsequently used to create a Dirac pulse at kₘₐₓ in block 1560. Finally, down-sampling is applied in a sample rate conversion step 1580 to return to the original sampling rate of fs. This will produce the new weights vₙ that present the fractional delay and represent the weights in variable delay element 1270.

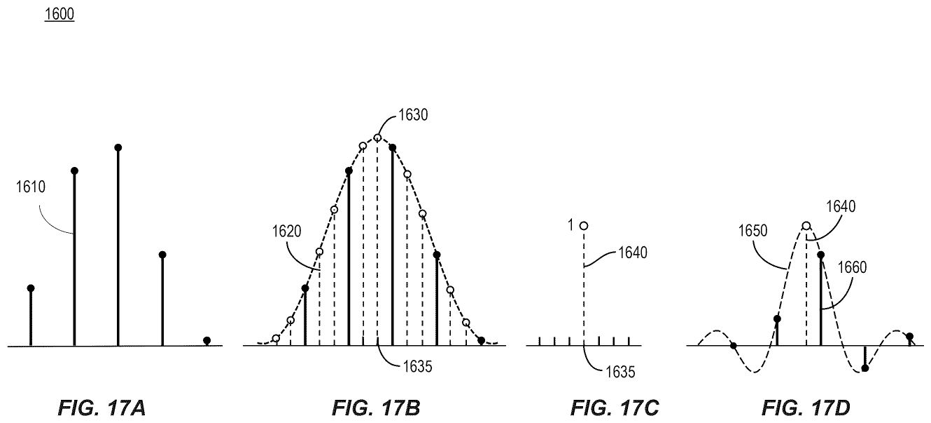

FIGS. 17A-D show the weights as found at different stages in the flow diagram 1500. An example of the original AF weights wₙ 1610 is shown in FIG. 17A. In FIG. 17B, the up-sampled weights w_{n,up} 1620 are shown. In this example, Nᵤₚ=3. The up-sampled weights 1620 have an improved timing resolution compared with the original weights 1610. Next, the maximum w_{n,upmax} upmax 1630 in the up-sampled weights 1620 is determined. The time point kₘₐₓ1635 where the maximum occurs is of importance. This time point 1635 is used to create a Dirac pulse 1640 at kₘₐₓ. In principle, this Dirac pulse 1640 represents the impulse response of an ideal delay with a delay kₘₐₓ/(N_{upfs}) at the up-sampled sample rate of N_{upfs}. However, to map this onto the original sample rate of fₛ, a down-sampling must be applied. Impulse response 1650 represents a reconstruction filter response which is re-sampled at fₛ. Impulse response 1650 is centered at the Dirac pulse 1640. The re-sampled values 1660 represent the new weights vₙ (sampled at f_{c}) that merely provide a delay and have no impact on the amplitude response (which is flat).

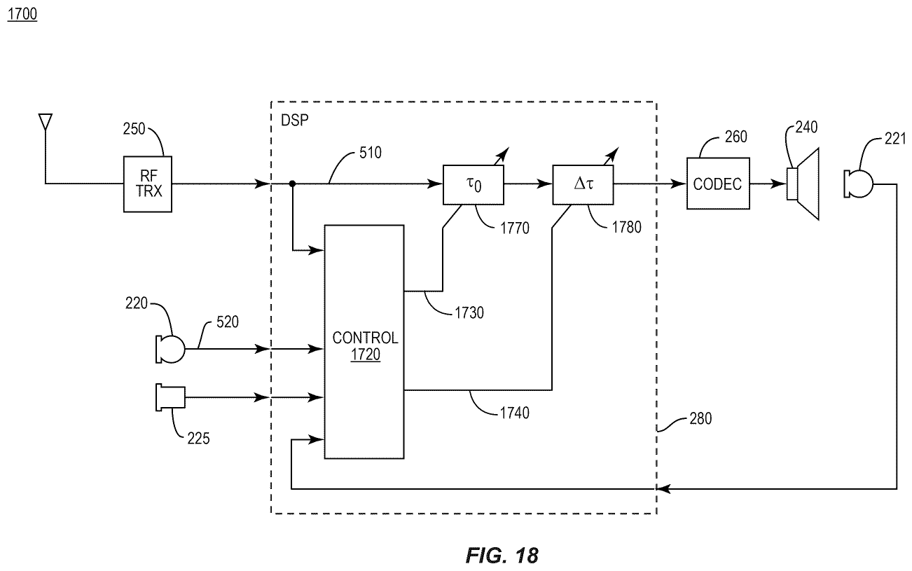

FIG. 18 shows a high level block diagram of a circuit to implement a second method to time synchronize the audio signals arriving via the air waves 120 and arriving via the wireless link 340 according to aspects of the present disclosure. Control block 1720 has as input the audio stream 510 from the radio 250 and the audio stream 520 from external microphone 220. In some aspects, the audio stream detected by vibration sensor 225 and/or internal microphone 221 may also be used. Via coarse tuning and fine tuning, control block 1720 creates two control signals 1730 and 1740, respectively. These control signals 1730 and 1740 set the initial coarse delay ^{τ}0 and the fine delay Δτ using delay elements 1770 and 1780. The coarse tuning may occur every minute, or it may be triggered when the fine tuning runs out of range or gives inconsistent results. For fine tuning using the first embodiment 700, inconsistent results are obtained when no optimal correlation signal B larger than both A and C can be found. For fine tuning using the second embodiment 1100 (or its derivatives), inconsistent results mean that the AF cannot find the proper delay, e.g., the impulse response does not fit into the weights of the AF. Negative delay value in fine tuning delay Δτ may be realized by applying an offset to coarse delay ^{τ}0. This offset may also be applied to center the impulse response in the adaptive filter.

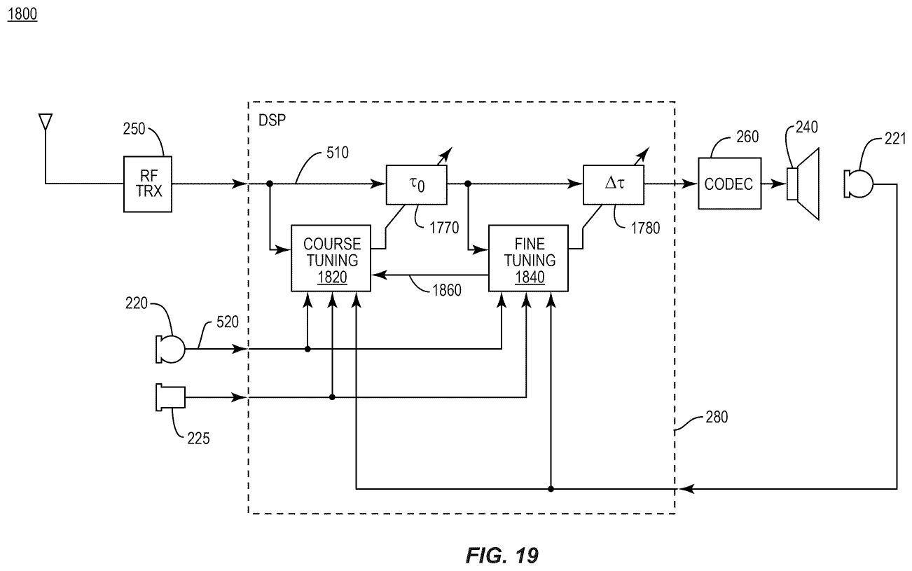

FIG. 19 shows a high level block diagram of a circuit implementing a third method to time synchronize the audio signals arriving via the air waves 120 and arriving via the wireless link 340 according to aspects of the present disclosure. The audio stream 510 from the radio is first delayed by an initial coarse delay ^{τ}0 in delay element 1770 and subsequently delayed by a fine delay Δτ using delay element 1780. The delay settings are determined in control blocks 1820 and 1840, respectively.

Headset 320 may be placed into a transparent mode, which means that the user may clearly hear all sounds in the environment, possibly at a reduced sound level to prevent damaging sound levels from reaching the eardrum. The transparency mode, for example, allows the user to communicate with people nearby. Passive transparency may be accomplished with canals or tubes in the earpiece that allow outside air waves to reach the ear canal. Possibly these canals may be opened and closed with valves which may be controlled electronically. Active transparency may be realized by using microphone 220 and loudspeaker 240. Sounds from the environment are detected by microphone 220, possibly processed in DSP 280 (e.g. amplifying, attenuating, equalizing, compressing, and the like, including, in some aspects, frequency-selectively shaping the sounds according to a predetermined program determined by the user's hearing response) and via codec 260, provided to loudspeaker 240, which will render the sounds to the user's eardrum. The audio signals picked up by microphone 220 will include both the music/sound from the (distant) stage loudspeaker 150 as well as sounds (e.g. voices) produced nearby. A combination of passive and active transparency may give the optimal hearing experience while still protecting against loud noises. For example, in case of a (music) festival, the music produced at the stage and received in headset 320 via the wireless link 340 may be combined with the audio received from the microphone 220 in the transparency mode.

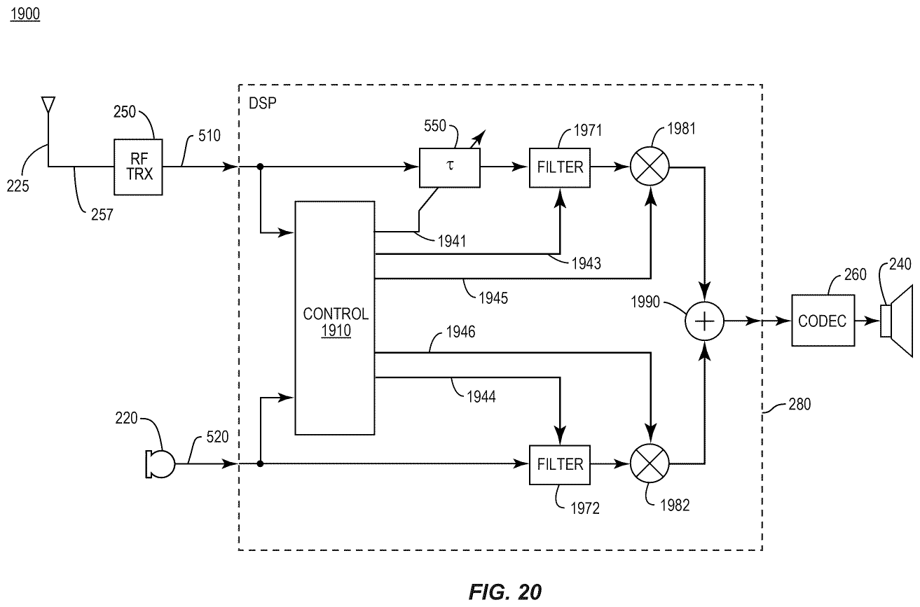

FIG. 20 shows a high level block diagram 1900 of a circuit implementing a method to combine the audio signals arriving via the air waves picked up by the microphone 220 for providing transparency, and the audio signals from a stage arriving via the wireless link 340 according to aspects of the present disclosure. Control block 1910 receives audio stream 510 from the radio 250 and audio stream 520 from the sound waves picked up in air microphone 220 for transparency. Control block 1910 determines the delay τ between the two audio streams 510 and 520. This delay is subsequently provided to delay element 550 via control signal 1941, which delays the audio stream 510 derived from the wireless link 340. Next, a filter 1971 may be applied, for example to reduce the low-frequency content, since low-frequency components may reach the user via the transparency path. The filter characteristics may be adaptive, depending on the distance between the listener and the stage (determining the amount of high-frequency attenuation by the air). Filter settings may be provided via control signal 1943. In multiplier 1981, a proper amplitude is set using a weight factor provided via control signal 1945. Similar actions are applied in the transparency path using microphone 220, filter 1972 and multiplier 1982. The transparency path is not delayed. The weighted signals from multiplier outputs 1981 and 1982 are added (combined) in adder 1990 and subsequently provided to loudspeaker 240 via codec 260. Proper weight factors are provided to the audio signals received via the radio path and the audio signals received via the transparency path to optimize the music listening experience and the ability to communicate with nearby persons, while still being protected against loud noises. The method of timing synchronization in control block 1910 may comprise any of the aspects described above. Control block 1910, delay element 550, filters 1971/1972, multipliers 1981/1982, and adder 1990 may be implemented as separate components or (partly or entirely) as an algorithm in DSP 280.

The time synchronization procedure as presented above may be carried out in the right earpiece 320a and left earpiece 320b separately. Alternatively, the procedure to determine the required delay may be carried out in a first earpiece 320a/320b, and the delay value found may be communicated wirelessly via the ear-to-ear link 370 to the second earpiece 320b/320a. Both the first and second earpiece 320 will subsequently provide the same delay to the audio received via radios 250a and 250b before it is presented to the loudspeakers 240a and 240b. Even when the delay values are determined independently in the right and left earpieces 320a, 320b, preferably the two earpieces 320 exchange their findings via link 370 and decide on a single delay value. This single delay value is then used by both earpieces 320. A difference in delay between the right and left earpieces 320a, 320b will be experienced negatively by the listener.

Aspects of the present disclosure provide numerous advantages over the prior art, and may achieve one or more of the technical effects. By transmitting audio to users'headsets via a radio link 340, in addition to the conventional air waves 120, improved sound fidelity is achieved by preserving high frequency components of the audio that degrade over distance. The user may also select from among a plurality of audio streams, customizing his or her listening experience. Additionally, the audio may be frequency-selectively shaped according to the user's hearing loss profile, further improving the audio experience. The headsets may further function as hearing protectors, reducing harmful sound levels while still allowing the user to enjoy the full spectrum audio. Numerous techniques are disclosed herein for time-synchronizing audio received via air waves 120 and via one or more radio links 340.

Generally, all terms used herein are to be interpreted according to their ordinary meaning in the relevant technical field, unless a different meaning is clearly given and/or is implied from the context in which it is used. All references to a/an/the element, apparatus, component, means, step, etc., are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the aspects disclosed herein may be applied to any other aspect, wherever appropriate. Likewise, any advantage of any of the aspects may apply to any other aspects, and vice versa. Other objectives, features and advantages of the enclosed aspects will be apparent from the description.

The terms “unit” and “block” may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein. As used herein, the term “configured to” means set up, organized, adapted, or arranged to operate in a particular way; the term is synonymous with “designed to,” or with respect to processing circuitry, “programmed to.”

The headset and its constituent earpieces are collectively referred to herein by the reference numeral 320. When discussing one or the other individual earpiece, they may be designated as 320a for the right earpiece and 320b for the left earpiece, where “right” and “left” are from the perspective of the user, as depicted in FIG. 3A. Where the two earpieces are referenced collectively but distinction between right and left is not critical, they may be refenced as either 320a/320b or simply 320.

Some of the aspects contemplated herein are described more fully with reference to the accompanying drawings. Other aspects, however, are contained within the scope of the subject matter disclosed herein. The disclosed subject matter should not be construed as limited to only the aspects set forth herein; rather, these aspects are provided by way of example to convey the scope of the subject matter to those skilled in the art. The present disclosure may, of course, be carried out in other ways than those specifically set forth herein without departing from essential characteristics of the disclosure. The present aspects are to be considered in all respects as illustrative and not restrictive, and all changes coming within the meaning and equivalency range of the appended aspects are intended to be embraced therein.

What is claimed is:

1. A method of enhancing audio, performed by a wireless stereo headset worn by a user positioned at a distance from a first audio source producing audio content, comprising:
receiving audio content from sound waves propagating through the air from the first audio source;
receiving a first audio signal by a radio receiver, whereby the first audio signal traveled wirelessly from a radio transmitter to the wireless stereo headset;
combining the received audio content and first audio signal to produce a processed audio signal including spectral components of the audio content that were attenuated by propagation of the sound waves through the air over the distance; and
rendering the processed audio content via a loudspeaker directed towards to the user's eardrum.

2. The method of claim 1 wherein:
receiving the audio content comprises generating a second audio signal by a microphone exposed to the ambient environment; and
combining the received audio content and first audio signal to produce a processed audio signal comprises:
time-synchronizing the first audio signal to the second audio signal; and
combining the time-synchronized first and second audio signals.

3. The method of claim 2 wherein time-synchronizing the first audio signal to the second audio signal comprises:
performing a coarse time synchronization to determine a coarse delay value that time-synchronizes the first audio signal to the second audio signal to a predetermined amount; and
performing a fine time synchronization after the coarse time synchronization, to more closely time-synchronizes the first audio signal to the second audio signal than applying the coarse delay value alone.

4. The method of claim 3 wherein the coarse time synchronization is performed in the frequency domain and the fine time synchronization is performed in the time domain.

5. The method of claim 3 wherein performing the fine time synchronization comprises determining a fine delay value that, when added to the coarse delay value, more closely time-synchronizes the first audio signal to the second audio signal than applying the coarse delay value alone.

6. The method of claim 5 wherein the fine time synchronization is performed by:
time-shifting the first audio signal by the coarse delay value;
further time-shifting the first audio signal by a plurality of amounts;
correlating each of the further time-shifted first audio signals to the second audio signal;
comparing the correlation magnitudes of the plurality of further time-shifted first audio signals to determine the fine delay value; and
time-shifting the first audio signal by a sum of the coarse and fine delay values.

7. The method of claim 6 wherein the plurality of time shift amounts comprises:
a candidate fine delay value Δτ yielding a correlation B with the second audio signal;
a lower fine delay value Δτ−δt yielding a correlation A with the second audio signal, where δt is a fixed time delay of one or a few sample periods; and
a higher fine delay value Δτ+δt yielding a correlation C with the second audio signal; and
wherein determining the fine delay value by comparing the correlation magnitudes of the plurality of further time-shifted first audio signals comprises:
in response to C>B>A, increasing the candidate fine delay value Δτ;
in response to A>B>C, decreasing the candidate fine delay value Δτ;
in response to (C>A>B or A>C>B), performing another coarse synchronization procedure to generate a new coarse delay value; and
otherwise, determining the fine delay value is the candidate fine delay value Δτ.

8. The method of claim 3 wherein the fine time synchronization is performed by:
time-shifting the first audio signal by the coarse delay value and a filter centering delay;
further time-shifting the first audio signal by an adaptive filter; and
dynamically adjusting first weights of the adaptive filter so as to minimize an error signal from a comparison of the second audio signal and further time-shifted first audio signal.

9. The method of claim 8 further comprising adjusting only the phase of the first signal and not the amplitude.

10. The method of claim 9 wherein adjusting only the phase of the first signal and not the amplitude comprises:
extracting a fine delay value from the first weights applied to the adaptive filter; and
further delaying the coarse time-shifted first audio signal by the fine delay value.

11. The method of claim 3 wherein the fine time synchronization is performed by:
time-shifting the first audio signal by the coarse delay value and a filter centering delay;
further time-shifting the first audio signal by an adaptive filter; and
dynamically adjusting first weights of the adaptive filter so as to minimize an error signal from a comparison of the second audio signal and the audio output of the loudspeaker as received by a feedback microphone within the wireless stereo headset.

12. The method of claim 8 wherein the first audio signal is sampled at a first sampling rate, and wherein dynamically adjusting first weights of the adaptive filter comprises:
increasing a sampling rate of the first filter weights to yield up-sampled filter weights;
identifying a maximum in the up-sampled filter weights and a sample point at which the maximum occurs;
creating a Dirac pulse at the sample point at which the maximum occurs; and
reducing the sampling rate of the up-sampled filter weights to the first sampling rate to generate second filter weights that include a fractional delay.

13. The method of claim 3 further comprising:
processing the first audio signal and the second audio signal in a control circuit to perform the coarse time synchronization and fine time synchronization, and outputting coarse and fine time synchronization control signals; and
delaying the first audio signal by coarse and fine delay values in response to the coarse and fine time synchronization control signals, respectively.

14. The method of claim 13, wherein the control circuit additionally processes the audio output of the loudspeaker as received by a feedback microphone within the wireless stereo headset to perform the coarse time synchronization and fine time synchronization.

15. The method of claim 13 wherein the control circuit is configured to perform an updated coarse time synchronization procedure periodically or in response to the fine time synchronization running out of range or giving inconsistent results.

16. The method of claim 13 wherein the control circuit comprises:
a coarse tuning control circuit configured to process the first and second audio signals, and output a coarse time synchronization control signal; and
a fine tuning control circuit configured to process the first signal delayed by a coarse delay value generated in response to the coarse time synchronization control signal and the second audio signal, and output a fine time synchronization control signal.

17. The method of claim 1 wherein the wireless stereo headset implements passive transparent mode wherein sound in the user's ambient environment is attenuated to prevent damage to the user's hearing, and passes through the wireless stereo headset to the user's eardrums.

18. The method of claim 1 wherein the wireless stereo headset implements active transparent mode wherein sound in the user's ambient environment is detected by a microphone, amplified, and rendered by the loudspeakers to the user's eardrums.

19. The method of claim 18 wherein sound detected by the microphone is further processed, including frequency-selectively amplification according to a predetermined profile specific to a user, to compensate for hearing loss.

20. A wireless stereo headset comprising:
a radio receiver configured to receive a first audio signal wirelessly transmitted from a transmitter;
a loudspeaker configured to render a processed audio signal and direct it towards a user's eardrum;
a battery; and
processing circuitry configured to combine audio content received from a first audio source producing audio content at a distance from the user, and the first audio signal, to produce the processed audio signal, which includes spectral components of the audio content that were attenuated by propagation of sound waves through the air over the distance.

21. The headset of claim 20 further comprising:
a microphone exposed to the ambient environment and configured to output a second audio signal including the audio content from the first source; and
wherein the processing circuitry is configured to combine the audio content and the first audio signal by:
time-synchronizing the first audio signal to the second audio signal; and
combining the time-synchronized first and second audio signals.

22. The headset of claim 21 wherein the processing circuitry is configured to time-synchronize the first audio signal to the second audio signal by:
performing a coarse time synchronization to determine a coarse delay value that time-synchronizes the first audio signal to the second audio signal to a predetermined amount; and
performing a fine time synchronization after the coarse time synchronization, to more closely time-synchronizes the first audio signal to the second audio signal than applying the coarse delay value alone.

23. The headset of claim 22 wherein the processing circuitry is configured to perform the coarse time synchronization in the frequency domain and the fine time synchronization in the time domain.

24. The headset of claim 22 wherein the processing circuitry is configured to perform the fine time synchronization by determining a fine delay value that, when added to the coarse delay value, more closely time-synchronizes the first audio signal to the second audio signal than applying the coarse delay value alone.

25. The headset of claim 24 wherein the processing circuitry is configured to perform the fine time synchronization by:
time-shifting the first audio signal by the coarse delay value;
further time-shifting the first audio signal by a plurality of amounts;
correlating each of the further time-shifted first audio signals to the second audio signal;
comparing the correlation magnitudes of the plurality of further time-shifted first audio signals to determine the fine delay value; and
time-shifting the first audio signal by a sum of the coarse and fine delay values.

26. The headset of claim 25 wherein the plurality of time shift amounts comprises:
a candidate fine delay value Δτ yielding a correlation B with the second audio signal;
a lower fine delay value Δτ−δt yielding a correlation A with the second audio signal, where δt is a fixed time delay of one or a few sample periods; and
a higher fine delay value Δτ+δt yielding a correlation C with the second audio signal; and
wherein the processing circuitry is configured to determine the fine delay value by comparing the correlation magnitudes of the plurality of further time-shifted first audio signals by:
in response to C>B>A, increasing the candidate fine delay value Δτ;
in response to A>B>C, decreasing the candidate fine delay value Δτ;
in response to (C>A>B or A>C>B), performing another coarse synchronization procedure to generate a new coarse delay value; and
otherwise, determining the fine delay value is the candidate fine delay value Δτ.

27. The headset of claim 22 wherein the processing circuitry is configured to perform the fine time synchronization by:
time-shifting the first audio signal by the coarse delay value and a filter centering delay;
further time-shifting the first audio signal by an adaptive filter; and
dynamically adjusting first weights of the adaptive filter so as to minimize an error signal from a comparison of the second audio signal and further time-shifted first audio signal.

28. The headset of claim 27 wherein the processing circuitry is further configured to adjust only the phase of the first signal and not the amplitude.

29. The headset of claim 28 wherein the processing circuitry is configured to adjust only the phase of the first signal and not the amplitude by:
extracting a fine delay value from the first weights applied to the adaptive filter; and
further delaying the coarse time-shifted first audio signal by the fine delay value.

30. The headset of claim 22 wherein the processing circuitry is configured to perform the fine time synchronization by:
time-shifting the first audio signal by the coarse delay value and a filter centering delay;
further time-shifting the first audio signal by an adaptive filter; and
dynamically adjusting first weights of the adaptive filter so as to minimize an error signal from a comparison of the second audio signal and the audio output of the loudspeaker as received by a feedback microphone within the wireless stereo headset.

31. The headset of claim 27 wherein the processing circuitry is configured to sample the first audio signal at a first sampling rate, and wherein the processing circuitry is configured to dynamically adjust first weights of the adaptive filter by:
increasing a sampling rate of the first filter weights to yield up-sampled filter weights;
identifying a maximum in the up-sampled filter weights and a sample point at which the maximum occurs;
creating a Dirac pulse at the sample point at which the maximum occurs; and
reducing the sampling rate of the up-sampled filter weights to the first sampling rate to generate second filter weights that include a fractional delay.

32. The headset of claim 22 wherein the processing circuitry is further configured to:
process the first audio signal and the second audio signal in a control circuit to perform the coarse time synchronization and fine time synchronization, and output coarse and fine time synchronization control signals; and
delay the first audio signal by coarse and fine delay values in response to the coarse and fine time synchronization control signals, respectively.

33. The headset of claim 32, wherein the control circuit is additionally configured to process the audio output of the loudspeaker as received by a feedback microphone within the wireless stereo headset to perform the coarse time synchronization and fine time synchronization.

34. The headset of claim 32 wherein the control circuit is configured to perform an updated coarse time synchronization procedure periodically or in response to the fine time synchronization running out of range or giving inconsistent results.

35. The headset of claim 32 wherein the control circuit comprises:
a coarse tuning control circuit configured to process the first and second audio signals, and output a coarse time synchronization control signal; and
a fine tuning control circuit configured to process the first signal delayed by a coarse delay value generated in response to the coarse time synchronization control signal and the second audio signal, and output a fine time synchronization control signal.

36. The headset of claim 20 further configured to implement passive transparent mode wherein sound in the user's ambient environment passes through the wireless stereo headset to the user's eardrums.

37. The headset of claim 36 wherein, in passive transparent mode, the ambient sound passed to the user's eardrums is attenuated to prevent damage to the user's hearing.

38. The headset of claim 20 further configured to implement active transparent mode wherein sound in the user's ambient environment is detected by a microphone, amplified, and rendered by the loudspeakers to the user's eardrums.

39. The headset of claim 38 wherein sound detected by the microphone is further processed, including frequency-selectively amplification according to a predetermined profile specific to a user, to compensate for hearing loss.
